(19) United States
(12) Patent Application Publication
(10) Pub. No.: US 2026/0367606 A1
(43) Pub. Date: Nov. 19, 2026

(54) TOOL-CHANGE-ORDER CALCULATION DEVICE AND COMPUTER-READABLE STORAGE MEDIUM

(71) Applicant: Yoshiyuki SUZUKI, Minamitsuru-gun, Yamanashi (JP)

(72) Inventor: Yoshiyuki SUZUKI, Minamitsuru-gun, Yamanashi (JP)

(21) Appl. No.: 19/136,519

(22) PCT Filed: Dec. 19, 2022
(86) PCT No.: PCT/JP2022/046751

§ 371 Date: Jun. 6, 2025

(51) Int. Cl. G05B 19/4093; G05B 19/4155

(52) U.S. Cl. CPC G05B 19/40938; G05B 19/4155

(57) ABSTRACT

This tool-change-order calculation device performs the following: storing a tool initial arrangement for associating the pot numbers of a magazine of a tool change device and tools mounted in the pots; obtaining an ideal arrangement for the tools in the magazine; simulating tool change orders for changing the order of tools from the initial arrangement in the magazine to the ideal arrangement; calculating evaluation values for the tool change orders; and selecting a tool change order on the basis of the evaluation values.

### CROSS REFERENCE TO RELATED APPLICATIONS

This is the U.S. National Phase application of PCT/JP2022/046751, filed Dec. 19, 2022, the disclosure of this application being incorporated herein by reference in its entirety for all purposes.

### FIELD OF THE INVENTION

The present disclosure relates to a tool-change-order calculation device and a computer-readable storage medium.

### BACKGROUND OF THE INVENTION

Conventionally, there are machine tools with a function of changing tools required for machining. These machine tools can use, for example, an automatic tool changer (ATC) to change the tools automatically.

Automatic tool changers include a turret type that selectively changes tools mounted in rotating tool pots and a magazine type that uses predetermined tool changing means to attach tools housed in a magazine to a spindle. The magazines are a drum type in which tools are arranged in a circle, a chain type in which tools are coupled with chains, and a matrix type in which tools are stocked in a rack, by way of example.

Some automatic tool changers also have a function of transporting tools by a specific loader from an additional external magazine.

There are conventional techniques for shortening time required for changing tools in which an analyzation is performed on a machining program to determine an arrangement of the tools suitable for the machining program. For example, Patent Literature 1 discloses such a technique.

The arrangement of the tools suitable for the machining program can reduce the time required for changing the tools.

### Patent Literature

[Patent Literature 1] Japanese Patent Laid-Open Publication No. H5-269635

### BRIEF DESCRIPTION OF THE DRAWINGS

FIG. 1 is a block diagram of a tool-change-order calculation device according to a first embodiment;

FIG. 2 is a schematic diagram showing a relationship between pot numbers of tools and an ideal arrangement;

FIG. 3 is a conceptual diagram showing a tool change order;

FIG. 4 is a flowchart illustrating an operation of the tool-change-order calculation device;

FIG. 5 is a block diagram of a tool-change-order calculation device according to a second embodiment;

FIG. 6 is an external view showing an example of a magazine having a tool rack;

FIG. 7 is a flowchart illustrating an operation of the tool-change-order calculation device according to the second embodiment;

FIG. 8 is a block diagram of a tool-change-order calculation device according to a fourth embodiment;

FIG. 9 is a schematic diagram illustrating a selection process for the ideal arrangement; and

FIG. 10 is a hardware configuration diagram of the tool-change-order calculation device.

### DETAILED DESCRIPTION OF EMBODIMENTS OF THE INVENTION

In conventional arts, the tools are not rearranged to an ideal arrangement from the start, and thus need to be changed into the ideal arrangement.

Thus, there is a need for a technique to increase the efficiency of tool rearrangement in the field of tool change.

A tool-change-order calculation device according to the present disclosure includes: an initial arrangement storage that stores an initial arrangement of tools with pot numbers of a magazine in a tool changing apparatus associated with tools mounted in pots; an ideal arrangement acquirer for acquiring an ideal arrangement of tools on the magazine; and an order calculator for performing a simulation on tool change orders for rearranging order of the tools in the initial arrangement on the magazine to the ideal arrangement, calculating evaluation values for the tool change orders, and selecting a tool change order based on the evaluation values.

### First Embodiment

A description will now be made about a tool-change-order calculation device 100 according to a first embodiment. The tool-change-order calculation device 100 is configured to acquire an arrangement of tools suitable for a usage condition of the tools (hereinafter referred to as ideal arrangement), and calculate orders of rearranging the tools to the ideal arrangement.

A method of determining the ideal arrangement is not limited. In here, two examples of the method for determining the ideal arrangement will be described.

One of the examples presents a method that determines an ideal arrangement suitable for a machining program. In this method, tools that are used frequently in the machining program are arranged in close proximity. By arranging the frequently-used tools in close proximity, the stroke of a magazine can be reduced during executing the machining program. An existing technique can be used to arrange the frequently-used tools in close proximity.

The other example presents a method that sets the ideal arrangement manually. An ideal arrangement receiver 18 receives an input of the ideal arrangement of the tools manually made. The ideal arrangement of the tools may be input by any means that enables the specification of correspondence between each tool and its position on the magazine where it is arranged. The ideal arrangement may be received in the tool-change-order calculation device 100, or it may be an ideal arrangement received in an external device.

The tool-change-order calculation device 100 is applied to an information processing device, such as a personal computer (PC), a server, and a handheld terminal. The tool-change-order calculation device 100 may also be applied to a control device, such as a numerical controller and a programmable logic controller (PLC).

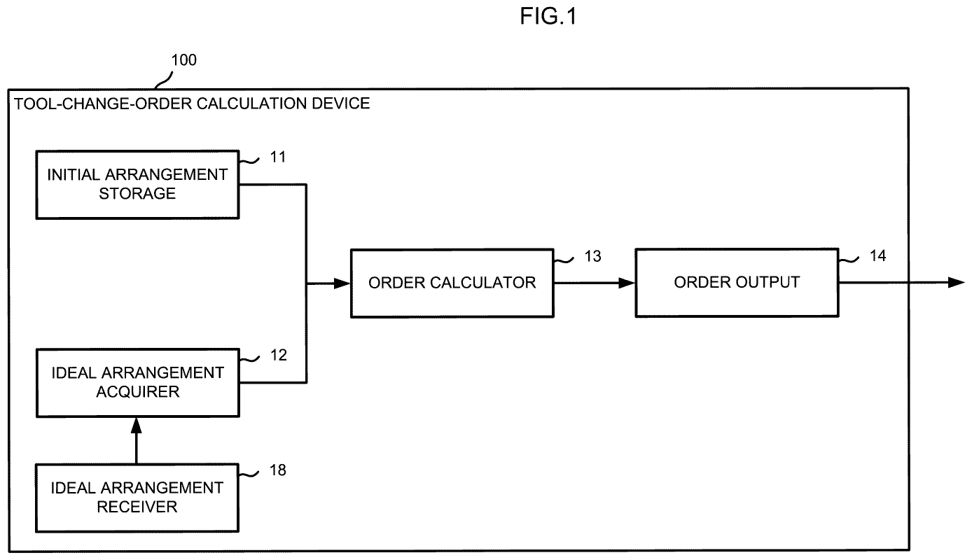

FIG. 1 is a block diagram of the tool-change-order calculation device 100. The tool-change-order calculation device 100 includes an initial arrangement storage 11, an ideal arrangement acquirer 12, an order calculator 13, an order output 14, and an ideal arrangement receiver 18.

The constituent elements of the tool-change-order calculation device 100 are classified according to their functions and thus may not be categorized clearly into physical components and program components.

The initial arrangement storage 11 is configured to store the arrangement of tools in a magazine or turret (hereinafter generically referred to as magazine). The magazine has tool holders called pots. The pots are numbered. The initial arrangement storage 11 stores information on a correspondence between pot numbers and the tools mounted in the pots before tool change. The arrangement of the tools before the tool change will be referred to as an initial arrangement.

The ideal arrangement acquirer 12 is configured to acquire an ideal arrangement of the tools. A way for calculating the ideal arrangement is based on an existing technique. The ideal arrangement may be calculated by the tool-change-order calculation device 100 or may be acquired from an external source.

The order calculator 13 is configured to calculate an order of the tool change for converting the initial arrangement of the tools into an ideal arrangement. The tool change is conditional on the presence of at least one empty pot. This empty pot may be one without any of the tools on the magazine mounted therein, or a spindle without a tool attached thereto may be used as the empty pot. Alternatively, a part to which a pot of a tool changer is attached or an empty area on a tool rack may be used as the empty pot. The order calculator 13 replaces the tools by using the empty pot.

The order calculator 13 is configured to simulate an order of tool change for rearranging the tools in the initial arrangement to an ideal arrangement, and calculate evaluation values that indicate efficiency of the tool change. The order calculator 13 then uses the calculated evaluation values to calculate orders of the tool change.

The order calculator 13 calculates at least one of two evaluation values (stroke of the magazine and number of moves) as an evaluation value indicating the efficiency of tool change.

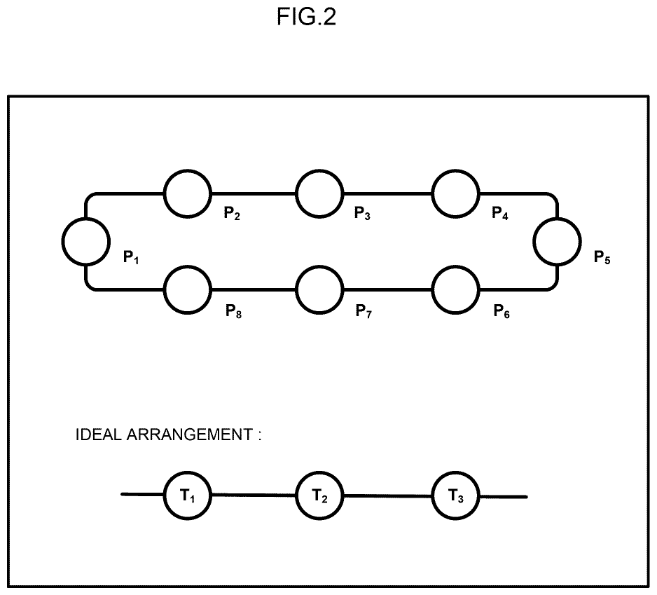

Prior to making a description about a method for calculating the evaluation value, the pot numbers of the tools and the ideal arrangement will be described by referring to FIG. 2. In this example, the number of pots in the magazine is eight, and the ideal arrangement of the tools is in the order of “T1, T2, T3”. The pots are numbered as “P1, P2, P3, P4, P5, P6, P7, P8”, clockwise from the left end.

The ideal arrangement of the magazine can take eight different patterns, i.e., an ideal arrangement pattern starting with “P1” to an ideal arrangement pattern starting with “P8”. There can be many ideal arrangements as there are pots.

The order calculator 13 simulates the tool change to rearrange the tools in the initial arrangement into the ideal arrangement. The simulation is performed for the number of pots. The evaluation value is calculated for each pot, and the lowest evaluation value is calculated as an order of tool change.

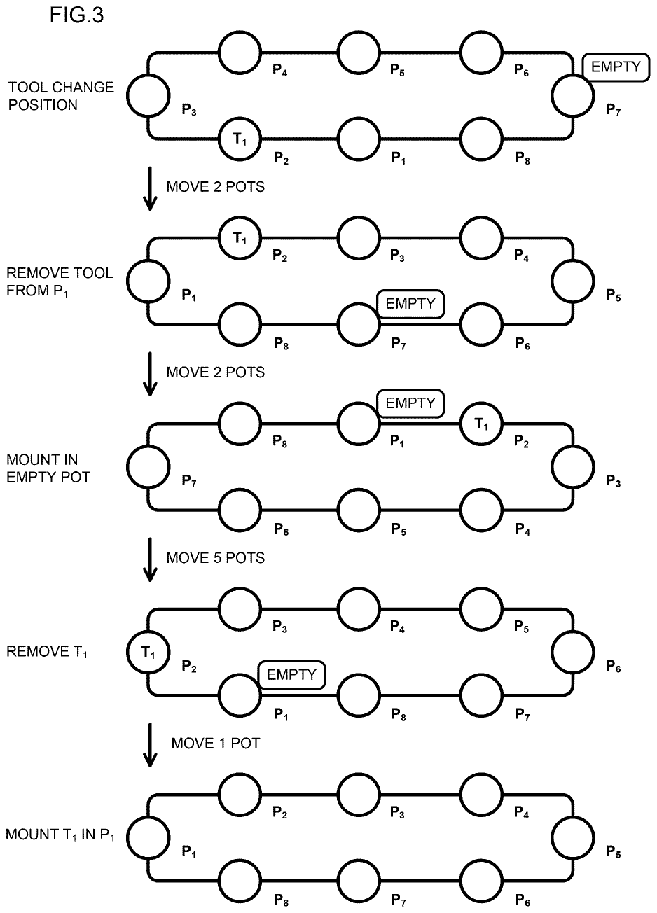

With reference to FIG. 3, an example of arranging the tool “T1” to the pot “P1” will be described. In this example, the magazine has at least one empty pot. This empty pot may be a pot in which no tools on the magazine are mounted, or a spindle with no tool attached may be used as the empty pot. Alternatively, a part to which a pot of a tool changer is attached or an empty area on a tool rack may be used as the empty pot. In this example, the simulation is performed to rearrange the tools to an order of “T1, T2, T3”, but the rearrangement order is not limited thereto. For example, the simulation may be performed to rearrange the tools in a reverse order with the tool “T3” at the end.

First, a description will be made about a simulation to arrange the tool “T1” to the pot “P1”. The order calculator 13 refers to the initial arrangement storage 11. In a case where the tool “T1” is placed in the pot “P1” in the initial arrangement, it is determined that the arrangement of the tool “T1” is completed and the simulation is performed to arrange the tool “T2” to the pot “P2”.

The initial arrangement shown in FIG. 3 does not have the tool “T1” in the pot “P1”. Thus, the order calculator 13 performs simulation to arrange the tool “T1” to the pot “P1”. In this simulation, the magazine is moved by two pots to move the pot “P1” to a tool change position. In the tool change position, the tool mounted in the pot “P1” is removed to make the pot “P1” empty. The magazine is in turn moved by two pots to move the empty pot on the magazine to the tool change position. In the tool change position, the tool removed from the pot “P1” is mounted in the empty pot. Then, the magazine is moved by five pots to move the tool “T1” to the tool change position. In the tool change position, the tool “T1” is removed. Subsequently, the magazine is moved by one pot to move the pot “P1” to the tool change position. In the tool change position, the tool “T1” is mounted in the pot “P1”. Thus, the simulation to arrange the tool “T1” to the pot “P1” is finished.

In the above-described simulation, the magazine is moved by “two pots”, “two pots”, “five pots”, and “one pot”. By adding a stroke and the number of moves of the magazine, the stroke and the number of moves of the magazine is calculated for arranging the tool “T1” to the pot “P1”.

Correspondingly, the stroke and the number of moves of the magazine are calculated for arranging the tool “T2” to the pot “P2” and the stroke and the number of moves of the magazine for arranging the tool “T3” to the pot “P3” are calculated, and then all the strokes and the numbers of the moves of the magazine are added up, so as to calculate an evaluation value (total stroke and total number of moves of the magazine) of changing the order of the tools into an ideal arrangement starting with the pot “P1”.

In a similar way, the determination is made about an evaluation value of an arrangement starting with the pot “P2” (total stroke of the magazine and tool change order), about an evaluation value of an arrangement starting with the pot “P3”, (snip), and about an evaluation value of an arrangement starting with the pot “P8”.

The order calculator 13 selects a tool change order with the lowest evaluation value (total stroke or total number of moves) as an ideal tool change order.

In the above-described example, the magazine is moved in only one direction, but may be turned in both directions. In the case of turning in both directions, the smaller one of two strokes is selected so as to calculate the total stroke and the total number of moves.

The order output 14 is configured to output the calculated tool change order. The outputting of the tool change order may be carried out by storing the tool change order in a file on an information processing device, such as PC, or in such a way that an NC program or sequence program for implementing the tool change order may be created and run on a numerical controller or PLC.

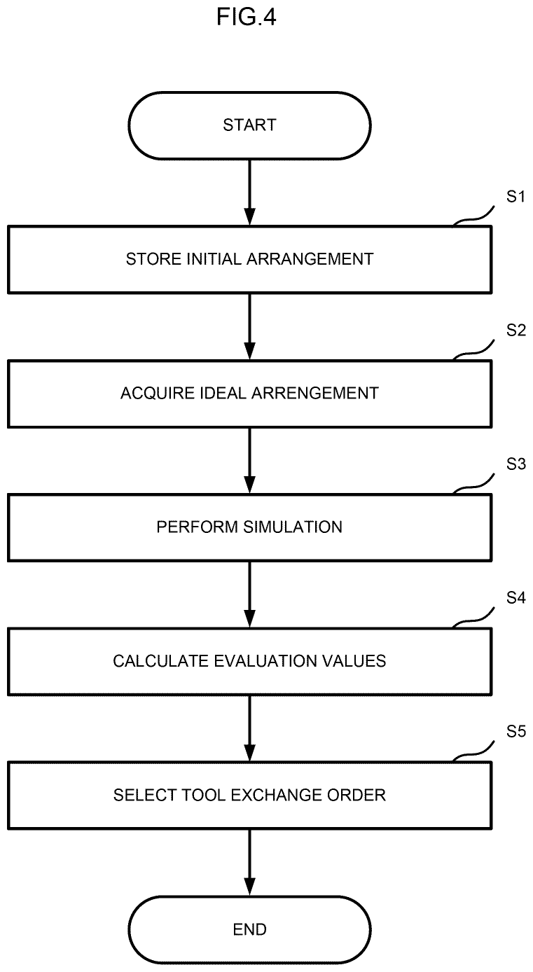

By referring to a flowchart in FIG. 4, an operation of the tool-change-order calculation device 100 will be described.

The tool-change-order calculation device 100 acquires information on a correspondence between pot numbers and tools before tool change, and stores the information in the initial arrangement storage 11 (step S1). The tool-change-order calculation device 100 acquires an ideal arrangement of the tools (step S2). The ideal arrangement may be acquired from an external source, or may be calculated by the tool-change-order calculation device 100.

The tool-change-order calculation device 100 performs a simulation to rearrange the tools in an initial arrangement to the ideal arrangement (step S3). This simulation uses empty pots to rearrange the tools to the ideal arrangement. The simulation can be performed for the number of pots on a magazine.

The tool-change-order calculation device 100 calculates evaluation values of tool change order (step S4). The tool-change-order calculation device 100 selects an efficient tool change order based on the calculated evaluation values (step S5).

The tool-change-order calculation device 100 of the first embodiment acquires the information on the correspondence between the pot numbers and the tools before the tool change, acquires the ideal arrangement of the tools, and performs the simulation to rearrange the tools from the initial arrangement before the tool change to the ideal arrangement. The tool-change-order calculation device 100 of the first embodiment calculates the evaluation value in each simulation, and selects the efficient tool change order based on the evaluation values.

The tool-change-order calculation device 100 of the first embodiment receives an ideal arrangement that is set manually. The tool-change-order calculation device 100 of the first embodiment can change the tools simply by specifying the ideal arrangement of the tools by on-screen operation, thereby making tool rearrangement more efficient.

The calculated tool change order may be stored in a file and output to another information processing device. Alternatively, a tool change program may be created based on the tool change order and output to the numerical controller or PLC, or the tool change program may be executed. Furthermore, the tool change order may be displayed to notify a user.

In the first embodiment, two evaluation values are calculated for the stroke and the number of moves of the magazine.

The selection of which evaluation value to use can be made based on the size of a tool changing apparatus and the structure of the tool changing apparatus. Alternatively, evaluation values for an evaluation taking into consideration of other factors may be used. The tool-change-order calculation device 100 may have a function of automatically selecting the type of the evaluation value, or may present a screen for selecting the evaluation value to the user and receive the selection from the user.

The stroke of the magazine is typically suitable as an evaluation value for a relatively small machine tool system consisting only of a magazine or turret. The number of moves of the magazine is suitable as an evaluation value for a large tool changing apparatus with an external tool rack or a machine tool system having a power-consuming tool changing apparatus.

### Second Embodiment

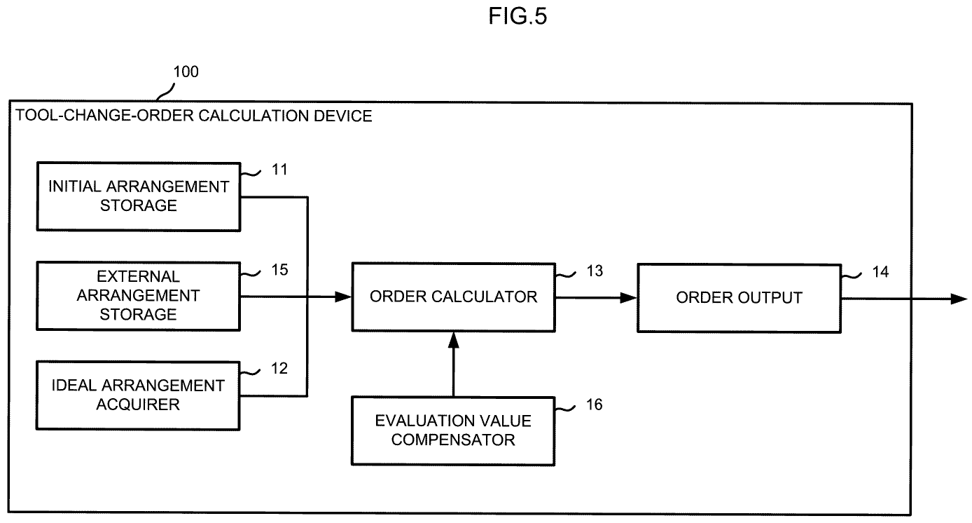

FIG. 5 is a block diagram of the tool-change-order calculation device 100 according to a second embodiment. The tool-change-order calculation device 100 of the second embodiment includes the initial arrangement storage 11, the ideal arrangement acquirer 12, the order calculator 13, the order output 14, an external arrangement storage 15, and an evaluation value compensator 16. The description about the constituent elements similar to those in the tool-change-order calculator 100 of the first embodiment will not be repeated below.

The tool-change-order calculation device 100 of the second embodiment is configured to calculate a tool change order for a tool changing apparatus having a tool rack.

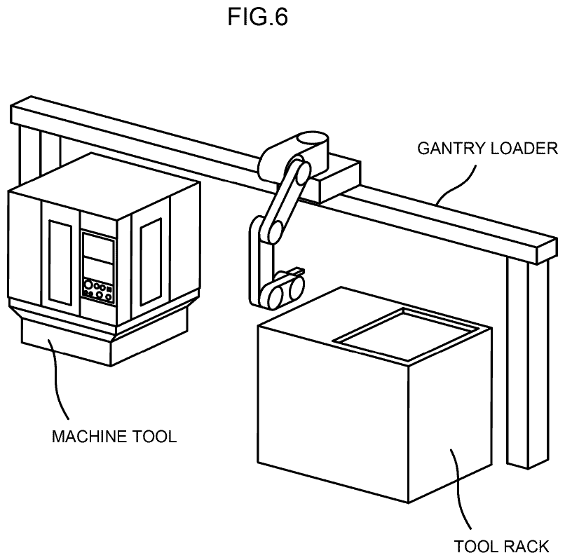

FIG. 6 shows an example of the automatic tool changer having the tool rack. The tool changing apparatus is configured to accommodate tools in a magazine and the tool rack. Between the magazine and the tool rack, a gantry loader is provided. The tool rack accommodates pallets with tools attached. The tools (hereinafter referred to as external tools) are attached to the pallets. The pallets housed in the tool rack are moved to the main body of the tool changing apparatus by means of the gantry loader. A robot is used to detach a tool from the main body of the tool changing apparatus and attach it to a machine tool. The tools may be attached/detached by using a device other than the robot, such as a tool changer.

The external arrangement storage 15 is configured to store an initial arrangement of external tools, i.e., a correspondence between pot numbers of the external tools and tools mounted in pots.

In tool change, moving the external tools housed in the tool rack is less efficient than moving the tools housed in the main body of the tool changing apparatus.

The evaluation value compensator 16 is configured to compensate evaluation values (number of moves) of the external tools housed in the tool rack. In the compensation of the evaluation values, the external tools and the tools in the main body may be preset to different evaluation values, or the number of moves of the external tools may be multiplied by a coefficient. In the embodiment, the evaluation values of the external tools are compensated to be higher than those of the magazine of the main body. The more times it is moved from and to the external tools, the higher the evaluation values, and thereby it is evaluated as inefficient.

The compensated values may reflect power consumption. For example, if the moving of an external tool consumes twice as much power, the number of times of tool change while moving from and to the external tool is doubled. It determines a tool change order with less power consumption.

The order calculator 13 of the second embodiment is configured to calculate the tool change order by using both the stroke and the number of moves of the magazine as evaluation values.

The tool-change-order calculation device 100 compares the numbers of moves of the magazine (after compensation) first, and if there is no difference in the numbers of moves, compares the strokes of the magazine so as to select a tool change order with less stroke.

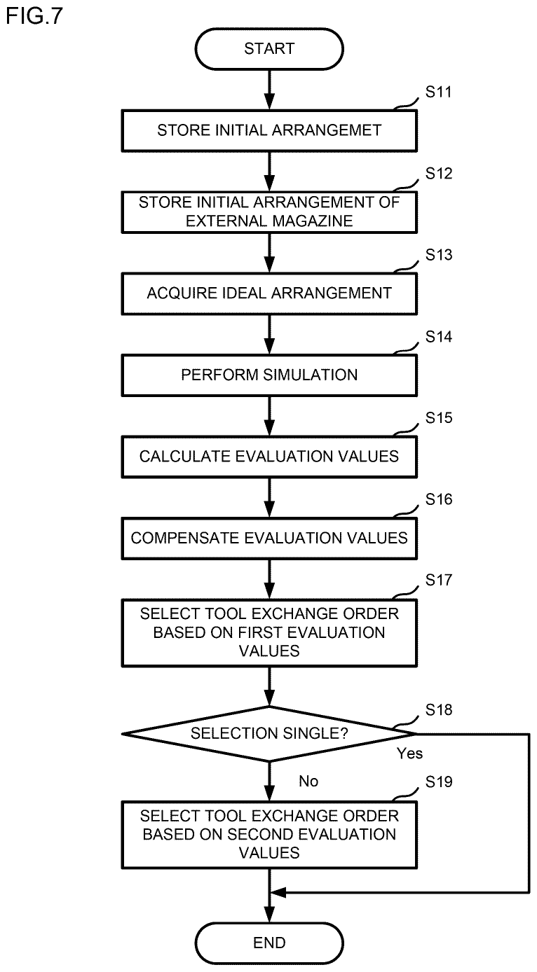

By referring to FIG. 7, a description will be made about an operation of the tool-change-order calculation device 100 of the second embodiment.

The tool-change-order calculation device 100 acquires an initial arrangement of the magazine in the main body and stores it in the initial arrangement storage 11 (step S11). The tool-change-order calculation device 100 then acquires an initial arrangement of the external magazine and stores it in the external arrangement storage 15 (step S12).

The tool-change-order calculation device 100 acquires an ideal arrangement of the tools (step S13). The ideal arrangement may be acquired from an external source, or may be calculated in the tool-change-order calculation device 100.

The tool-change-order calculation device 100 performs a simulation to rearrange the tools in the initial arrangement into the ideal arrangement (step S14). This simulation uses empty pots to rearrange the tools to the ideal arrangement. The simulation can be performed for the number of pots on the magazine.

The tool-change-order calculation device 100 calculates evaluation values for the tool change order (step S15). In a case where any tools are moved from the tool rack, compensation is made on the evaluation values (step S16). The tool-change-order calculation device 100 uses the number of moves of the magazine as a first evaluation value. The tool-change-order calculation device 100 selects an efficient tool change order based on the number of moves of the magazine (step S17).

When there is one selection in step S17 (step S18: Yes), the tool-change-order calculation device 100 terminates the process of selecting the tool change order.

In step S17, when there are multiple tool change orders having the same evaluation value (step S18: No), the tool-change-order calculation device 100 uses the stroke of the magazine as a second evaluation value. The tool-change-order calculation device 100 then selects an efficient tool change order based on the strokes of the magazine (step S19).

The tool-change-order calculation device 100 of the second embodiment calculates a tool change order suitable for a tool changing apparatus having the tool rack. The number of moves of the magazine from the tool rack is subjected to a compensation process.

An amount of compensation can be calculated based on power consumption to move the tools from the tool rack to the main body and within the magazine of the main body. The evaluation values can be used to promote the efficiency of the power consumption.

The tool-change-order calculation device 100 of the second embodiment uses two kinds of evaluation values, namely the first evaluation values (numbers of moves of magazine) and the second evaluation values (strokes of magazine), to select a tool change order. The first evaluation values (number of moves of magazine) are used first, and in a case where there is no difference in the first evaluation values (including a case where there is a small difference), the second evaluation values (strokes of magazine) are used to select the tool change order.

### Third Embodiment

The order calculator 13 of the tool-change-order calculation device 100 according to a third embodiment has a function of calculating evaluation values by taking into consideration a pot that is occupied by a large-diameter tool. The large-diameter tool may come into contact with a tool mounted in a pot close to the pot in which the large-diameter tool is mounted. Thus, a pot (this pot is defined depending on the size and shape of the large-diameter tool) close to the pot with the large-diameter mounted is defined as an empty pot, and based on this condition, a simulation of tool change is performed to calculate a tool change order.

### Fourth Embodiment

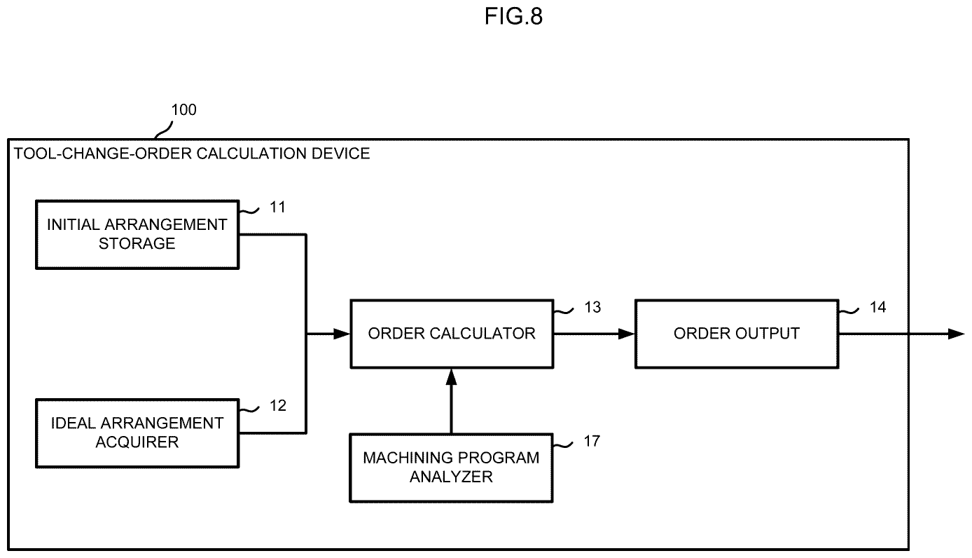

The order calculator 13 of the tool-change-order calculation device 100 according to a fourth embodiment calculates an evaluation value by taking into consideration an indexed stroke. As a precondition, the tool-change-order calculation device 100 includes a machining program analyzer 17, as shown in FIG. 8. The machining program analyzer 17 is configured to analyze a machining program to determine a first tool to be changed when the machining program is executed. The order calculator 13 determines a pot number for the first tool to be changed. Then, the order calculator 13 calculates an indexed stroke to move the first tool to be changed to a tool change position. Subsequently, the order calculator 13 adds the indexed stroke to a total stroke of the magazine calculated by a simulation to thereby calculate the evaluation value.

The tool-change-order calculation device 100 of the fourth embodiment can calculate an evaluation value by taking into consideration an index stroke when a tool change specified by the machining program is carried out.

### Fifth Embodiment

The order calculator 13 of the tool-change-order calculation device 100 according to a fifth embodiment selects a pot with less stroke during the tool change to perform a simulation. More specifically, the order calculator 13 selects a tool to be rearranged to an ideal arrangement, and performs a simulation of a tool change order on a pot close to an initial arrangement of the selected tool but not on a pot distant from the initial arrangement of the selected tool.

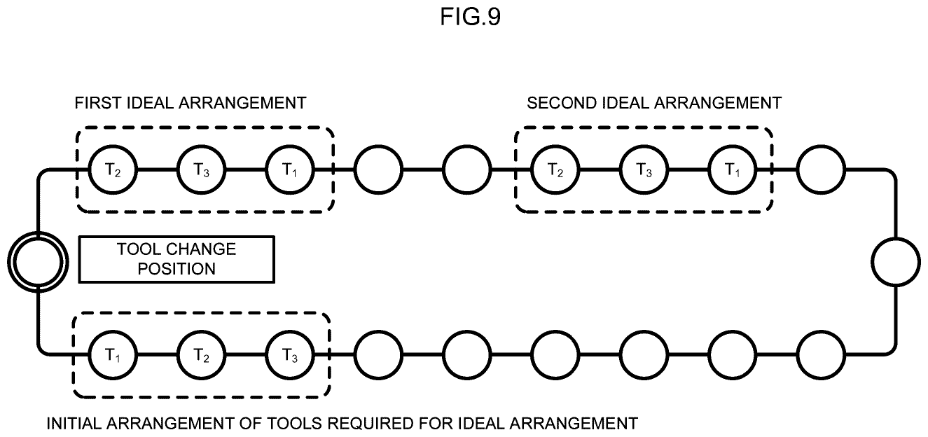

The example shown in FIG. 9 selects a first ideal arrangement close to the initial arrangement of the tool to be rearranged to the ideal arrangement, and does not perform the simulation on a second ideal arrangement distant from the initial arrangement of the tool to be rearranged to the ideal arrangement.

Since the first ideal arrangement in the example of FIG. 9 is also close to the tool change position, the stroke to move to the tool change position is also small.

Since the tool-change-order calculation device 100 of the fifth embodiment performs the simulation by selecting the pot with less stroke during the tool change, an amount of simulation calculation can be reduced.

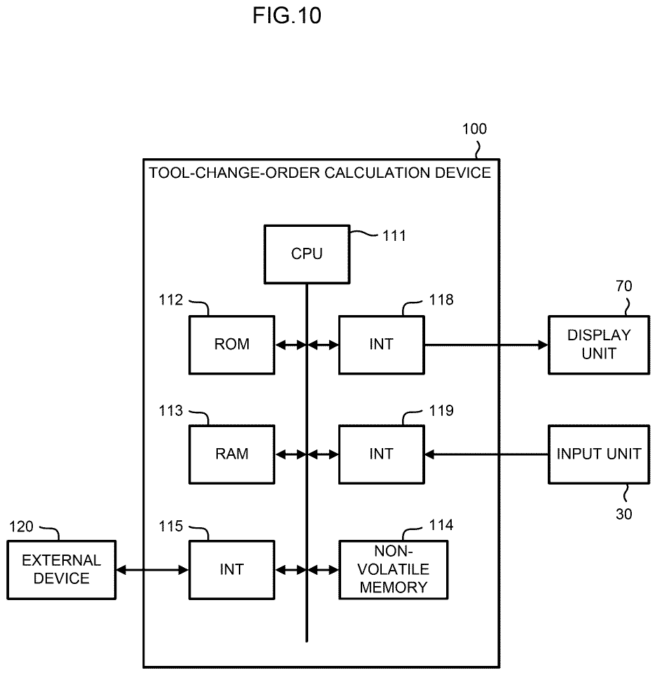

Now, a description will be made about a hardware configuration of the tool-change-order calculation device 100 employing the present disclosure. FIG. 10 is a hardware configuration diagram of the tool-change-order calculation device 100. The tool-change-order calculation device 100 includes, as shown in FIG. 10, a central processing unit (CPU) 111 configured to control the entire tool-change-order calculation device 100, a ROM 112 configured to store programs and pieces of data, and a RAM 113 configured to temporarily expand data. The CPU 111 reads a system program stored in the ROM 112 via a bus to conduct tool change order calculation according to the system program.

A non-volatile memory 114 is backed up by a battery not shown, for example, so that storage conditions can be retained even when a power source of the tool-change-order calculation device 100 is turned off. The non-volatile memory 114 is configured to store programs read from an external device 120 via interfaces 115, 118 and 119, and various data, such as user operations, input through an input device 30. The non-volatile memory 114 may store programs and pieces of data for conducting the tool change order calculation. Furthermore, a display unit 70 is provided to display various data.

The interface 115 is configured to connect the tool-change-order calculation device 100 to the external device 120, such as an adaptor. From the external device 120, programs, parameters and others can be read out.

The present disclosure has been described in detail as above, but is not limited to the above-described embodiments. Thus, various additions, substitutions, modifications, partial deletions and so on may be made to these embodiments without departing from the gist of the disclosure or the spirit of the disclosure as derived from the contents described in the appended claims and their equivalents. Furthermore, these embodiments can be implemented by combining them. For example, the order of the operations and the order of the processes in these embodiments are provided by way of example, and thus are not limited thereto.

Supplementary notes on the embodiments of the present disclosure will be presented below.

### Supplementary Note 1

A tool-change-order calculation device (100) according to one mode of the present disclosure includes: an initial arrangement storage (11) for storing an initial arrangement of tools with pot numbers of a magazine in a tool changing apparatus associated with tools mounted in pots; an ideal arrangement acquirer (12) for acquiring an ideal arrangement of tools on the magazine; and an order calculator (13) for performing a simulation on tool change orders for rearranging the tools in the initial arrangement on the magazine to the ideal arrangement, calculating evaluation values for the tool change orders, and selecting a tool change order based on the evaluation values.

### Supplementary Note 2

In the tool-change-order calculation device (100) according to an alternative mode of the present disclosure, the evaluation values are strokes of the magazine.

### Supplementary Note 3

In the tool-change-order calculation device (100) according to an alternative mode of the present disclosure, the evaluation values are numbers of moves of the magazine.

### Supplementary Note 4

In the tool-change-order calculation device (100) according to an alternative mode of the present disclosure, the order calculator (13) calculates the numbers of moves of the magazine as first evaluation values and the strokes of the magazine as second evaluation values, and when there is no difference in the first evaluation values, uses the second evaluation values to select the tool change order.

### Supplementary Note 5

The tool-change-order calculation device (100) according to an alternative mode of the present disclosure includes an external arrangement storage (15) storing an initial arrangement of an external magazine housed in a tool rack of the tool changing apparatus by associating pot numbers of the external magazine with tools mounted in pots, and further includes an evaluation value compensator (16) for compensating, when the simulation includes a change of tools housed in the external magazine, evaluation values for the tool change.

### Supplementary Note 6

In the tool-change-order calculation device (100) according to an alternative mode of the present disclosure, the order calculator (13) compensates evaluation values based on power consumption required for moving the tools housed in the external magazine.

### Supplementary Note 7

In the tool-change-order calculation device (100) according to an alternative mode of the present disclosure, when the tools include a large-diameter tool, the order calculator (13) performs a simulation on the tool change order on condition that a pot close to the large-diameter tool is defined as an empty pot.

### Supplementary Note 8

The tool-change-order calculation device (100) according to an alternative mode of the present disclosure includes a machining program analyzer (17) for analyzing a machining program, in which the machining program analyzer (17) determines a first tool to be changed when the machining program is executed, and the order calculator (13) calculates an evaluation value by adding an indexed stroke of the first tool to be changed to a total stroke of the magazine calculated by the simulation.

### Supplementary Note 9

In the tool-change-order calculation device (100) according to an alternative mode of the present disclosure, the order calculator (13) selects tools to be rearranged to the ideal arrangement and then selects pots close to the initial arrangement of the tools, so as to perform the simulation.

### Supplementary Note 10

The tool-change-order calculation device 100 according to an alternative mode of the present disclosure includes an ideal arrangement receiver (18) for receiving an input of an ideal arrangement of the tools.

### Supplementary Note 11

A storage medium storing computer-readable commands according to one mode of the present disclosure stores commands that cause one or more processors to conduct: a step of storing an initial arrangement of tools with pot numbers of a magazine in a tool changing apparatus associated with tools mounted in pots; a step of acquiring an ideal arrangement of tools on the magazine; and a step of performing a simulation on tool change orders to rearrange the tools in the initial arrangement on the magazine to the ideal arrangement, calculating evaluation values for the tool change order, and selecting a tool change order based on the evaluation values.

1. A tool-change-order calculation device, comprising:
an initial arrangement storage for storing an initial arrangement of tools with pot numbers of a magazine in a tool changing apparatus associated with tools mounted in pots;
an ideal arrangement acquirer for acquiring an ideal arrangement of tools on the magazine; and
an order calculator for performing a simulation on tool change orders for rearranging the tools in the initial arrangement on the magazine to the ideal arrangement, calculating evaluation values for the tool change orders, and selecting a tool change order based on the evaluation values.

2. The tool-change-order calculation device according to claim 1, wherein the evaluation values are strokes of the magazine.

3. The tool-change-order calculation device according to claim 1, wherein the evaluation values are numbers of moves of the magazine.

4. The tool-change-order calculation device according to claim 1, wherein the order calculator calculates the numbers of moves of the magazine as first evaluation values and the strokes of the magazine as second evaluation values, and
when there is no difference in the first evaluation values, uses the second evaluation values to select the tool change order.

5. The tool-change-order calculation device according to claim 1, comprising an external arrangement storage storing an initial arrangement of an external magazine housed in a tool rack of the tool changing apparatus by associating pot numbers of the external magazine with tools mounted in pots, and
further comprising an evaluation value compensator for compensating, when the simulation includes a change of tools housed in the external magazine, evaluation values for the tool change.

6. The tool-change-order calculation device according to claim 5, wherein the order calculator compensates evaluation values based on power consumption required for moving the tools housed in the external magazine.

7. The tool-change-order calculation device according to claim 1, wherein when the tools include a large-diameter tool, the order calculator performs a simulation on the tool change order on condition that a pot close to the large-diameter tool is defined as an empty pot.

8. The tool-change-order calculation device according to claim 2, comprising a machining program analyzer for analyzing a machining program, wherein
the machining program analyzer determines a first tool to be changed when the machining program is executed, and
the order calculator calculates an evaluation value by adding an indexed stroke of the first tool to be changed to a total stroke of the magazine calculated by the simulation.

9. The tool-change-order calculation device according to claim 1, wherein the order calculator selects tools to be rearranged to the ideal arrangement and then selects pots close to the initial arrangement of the tools, so as to perform the simulation.

10. The tool-change-order calculation device according to claim 1, comprising an ideal arrangement receiver for receiving an input of an ideal arrangement of the tools.

11. A storage medium that stores computer-readable commands for causing one or more processors to conduct:
a step of storing an initial arrangement of tools with pot numbers of a magazine in a tool changing apparatus associated with tools mounted in pots;
a step of acquiring an ideal arrangement of tools on the magazine; and
a step of performing a simulation on tool change orders to rearrange the tools in the initial arrangement on the magazine to the ideal arrangement, calculating evaluation values for the tool change order, and selecting a tool change order based on the evaluation values.
